(19) United States
(12) Patent Application Publication
(10) Pub. No.: US 2006/0047756 A1
(43) Pub. Date: Mar. 2, 2006

(54) Method and apparatus for indicating truncated email information in email synchronization

(76) Inventors: Jussi Piispanen, Tampere (FI); Mikko Hakala, Tampere (FI); Petri Lehtovirta, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/869,504

(22) Filed: Jun. 16, 2004

(51) Int. Cl. G06F 15/16

(52) U.S. Cl. 709/206

(57) ABSTRACT

A method by which an email synchronization server (11) communicates to an email synchronization client (12) that an email being provided to the client (12) by the server (11) during a synchronization session is truncated, based on including in a description of the email a truncated element (21) and also, as appropriate, a body element (22) and/or one or more attach elements (23).

### TECHNICAL FIELD

The present invention pertains to the field of email. More particularly, the present invention pertains to synchronizing email in different devices.

### BACKGROUND ART

Various mobile different devices—handheld computers, mobile phones, pagers, laptop computers—may all synchronize their data, and may do so with respect either to each other or with respect to a network or desktop computer application (such as a desktop calendar) or with respect to other devices where information is stored. Email synchronization is standardized by the so-called Open Mobile Alliance (OMA); the standard is currently specified in SyncML Specification version 1.0.1. In email synchronization, a device acting as a synchronization server synchronizes email with two or more other, client devices. The OMA specifications also include email object specifications that define the content and format of email being synchronized, i.e. the representation of the email within the data synchronization context. The specification that does this currently is “Email data object specification,” version 1.2, draft version, 19 Jan. 2004.

The synchronization server may truncate an e-mail in some way before sending it to a client (because e.g. the email client has indicated to the synchronization server that no attachments are to be provided when synchronizing). For example, an attachment may be left out. The current standard does not provide any means by which the synchronization server can indicate whether some part of an email has not been transferred, i.e. whether the email has been in any way truncated.

It would be advantageous for an email receiving device to receive some kind of an indication of truncation when a truncated email is provided to the device.

### DISCLOSURE OF THE INVENTION

Accordingly, in a first aspect of the invention, a method is provided, comprising: a step in which a synchronization server determines an email to send to a synchronization client and determines what if any parts of the email to omit; and a step in which the synchronization server sends the email in whole or in part to the synchronization client and describes what if any parts of the email are omitted, wherein the description is provided using an extensible markup language.

In accord with the first aspect of the invention, the description may include a truncated element for indicating whether any parts of the email are omitted. Further, the truncated element may include a body element for indicating that a part of the body of the email is omitted or an attach element for indicating that an attachment is omitted.

Also in accord with the first aspect of the invention, the synchronization client may also indicate the size of at least some omitted parts.

In a second aspect of the invention, a computer program product is provided comprising a computer readable storage structure embodying computer program code thereon for execution by a computer processor, wherein said computer program code comprises instructions for performing a method including: a step of determining an email to send to a client device and of determining what if any parts of the email to omit; and a step of sending the email in whole or in part to the client device and of describing what if any parts of the email are omitted, wherein description is provided using an extensible markup language.

In a third aspect of the invention a method is provided, comprising: a step in which an email client apparatus having email client functionality and having email folders receives from a synchronization server apparatus an email in whole or in part as well as a description of what if any parts are omitted, wherein the description is provided using an extensible markup language; and a step in which the email client displays information indicating whether only part of the email is received.

In a fourth aspect of the invention, a computer program product is provided comprising a computer readable storage structure embodying computer program code thereon for execution by a computer processor, wherein said computer program code comprises instructions for performing a method including: a step of receiving from a server apparatus an email in whole or in part as well as a description of what if any parts are omitted, wherein description is provided using an extensible markup language; and a step of displaying information indicating whether only part of the email is received.

In a fifth aspect of the invention, a synchronization server apparatus is provided, comprising: means for determining an email to send to a synchronization client and for determining what if any parts of the email to omit; and means for sending the email to the synchronization client in whole or in part and for describing what if any parts of the email are omitted, wherein the email is described using an extensible markup language.

In a sixth aspect of the invention, a synchronization client apparatus having email folders is provided, comprising: means for receiving from a synchronization server apparatus an email in whole or in part as well as a description of what if any parts are omitted, wherein description is provided using an extensible markup language; and means for displaying information indicating whether only part of the email is received.

In a seventh aspect of the invention, a system is provided, comprising a synchronization server apparatus according to the fifth aspect of the invention and also comprising at least one synchronization client apparatus according to the sixth aspect of the invention.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram/flow diagram of a system according to the invention, including an email synchronization server apparatus (indicated as an email synch server in the figure) and an email synchronization client apparatus (indicated as an email synch client in the figure).

FIG. 2 is a schematic illustration of elements of a description of an email to be included by the email synchronization server in a communication of an email to the email synchronization client.

FIG. 3 is a method according to the invention, by which the email synchronization server and email client synchronize the email folders on the email synchronization client based on the email client receiving from the email synchronization server an email and a description of the email including the elements illustrated in FIG. 2.

### DETAILED DESCRIPTION OF THE INVENTION

According to the invention, the server performing the email synchronization—i.e. the device performing the server role in a client-server model for synchronization, even if the device is a mobile station—specifies whether the email is in any way truncated in XML script describing the email. More specifically, the XML describing the email is provided so as to contain an XML element—called here the truncated element—indicating each omitted part of the email and also the size and type of the omitted part. The email client on the device receiving the XML description then parses the description and so obtains the indication without having to examine the email data itself.

The data type definition (DTD) specification for the truncated element (of the XML description) according to the invention can be as follows:

<!ELEMENT truncated (body?, attach*)>
<!ELEMENT body (size?, type?)>
<!ELEMENT attach (name?, size?, type?)>

so that it includes a body element and an attach element.

The email object DTD is extended to include the truncated element:
<!ELEMENT Email (read?, forwarded?, replied?, received?, created?, deleted?, flagged?, emailitem?, truncated?, Ext*)>

As an example of the use of the XML description of an email as modified by the invention, suppose that the email body is truncated so that 1235 bytes of the body is still left on the server (and is not included in the email provided to the email client being synchronized), and also that two attachments—a brand xx word processor document and a brand yy presentation document—are omitted. Then the modified XML description could be as follows:

<Replace>

<CmdID>6</CmdID>
<Meta>

<Type xmlns=‘syncml:metinf’>application/vnd.omads-email</Type>

</Meta>
<Item>

<Source>

<LocURI>123</LocURI>

</Source>
...
<Data><![CDATA[

<Email>

<created>20030807T231830Z</created>
<read>false</read>
<emailitem>
<--! The content of the email as specified by RFC 2822 -->
<![CDATA[From: <sender@mail.com>
To: <receiver@mail.com>
... ]]&gt;
</emailitem>
<truncated>

<body>

<size>1235</size> <!--1235 bytes of the body left -->

</body>
<attach>

<name>specification.doc</name>
<size>15000</size> <!--15000 bytes of attachment -->
<type>application/xx-word-processor-document</type>

</attach>
<attach>

<name>slideshow.ppt</name>
<size>37500</size>
<type>application/yy-presentation-document</type>

</attach>

</Email>]]>

</Data>

</Item>

</Replace>

The usage of the truncated element is advantageously mandatory for a server, but the usage of the elements within the truncated element is advantageously optional. By utilizing the body element within the truncated element, the server can specify if the body of the email was truncated, and the size (in bytes) of the part of the body left on the server (and not provided to the email client). The attach element can be used to specify the number of attachments, and the names, types and the sizes (in bytes) of the attachments still on the server. The server advantageously specifies the body element only if the body part of the email is truncated, and only once. The server advantageously specifies the attach elements only if attachments are omitted, and specifies one attach element per attachment. By utilizing just the truncated element—and not also the body and attach elements—the server can indicate to the client that the email object is truncated, without providing any more detailed information; making it optional for the server to use the body and attach elements, the server need not obtain information about the omitted body and attachments, which is advantageous because sometimes such information is not readily available to the server.

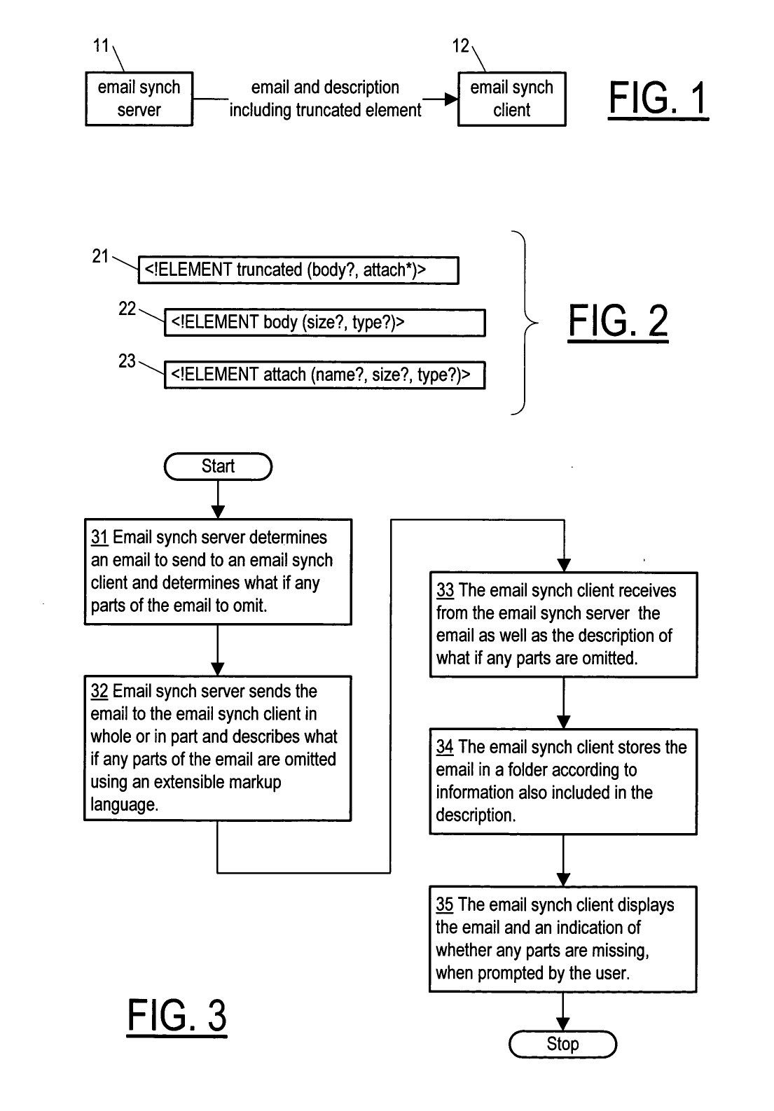

Referring now to FIGS. 1-2, a system according to the invention is shown as including an email synchronization server 11 (e.g. a desktop computer hosting email synchronization server functionality) communicating to an email synchronization client 12 (e.g. a mobile station hosting email synchronization client functionality) an email and a corresponding description including a truncated element 21 that in turn includes, as appropriate, a body element 22 and/or one or more attach elements 23. As indicated, the body element 22 and attach elements 23 advantageously include a size parameter for indicating the size of the omitted body part or attachments.

Referring now also to FIG. 3, the invention is shown as providing a method including a first step 31 in which the synchronization server 11 determines an email to send to the synchronization client 12 and determines what if any parts of the email to omit, e.g. based on a filter set by the email synchronization client 12 and previously communicated to the email synchronization server 11. In a next step 32, the synchronization server 11 sends the email in whole or in part to the synchronization client 12 and describes what if any parts of the email are omitted using an extensible markup language. In a next step 33, the email client receives (all or part of) the email from the email server and also receives the description of what if any parts are omitted. In a next step 34, the email client saves the email in a folder of the email client. In a next step 35, the email client displays the email and an indication of whether any parts are missing, when prompted by the user, as e.g. when the user scrolls through the email in the folder where the email is stored. The indication displayed by the email client advantageously indicates not only whether any parts are omitted, but also what parts.

The invention is described above in terms of a method. Besides a method, the invention also encompasses a corresponding computer program product including a computer readable storage structure embodying computer program code—i.e. software or firmware—thereon for execution by a computer processor.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
a step in which a synchronization server determines an email to send to a synchronization client and determines what if any parts of the email to omit; and
a step in which the synchronization server sends the email in whole or in part to the synchronization client and describes what if any parts of the email are omitted, wherein the description is provided using an extensible markup language.

2. A method as in claim 1, wherein the description includes a truncated element for indicating whether any parts of the email are omitted.

3. A method as in claim 2, wherein the truncated element includes a body element for indicating that a part of the body of the email is omitted or an attach element for indicating that an attachment is omitted.

4. A method as in claim 3, wherein the body element indicates the size of the omitted part of the body.

5. A method as in claim 3, wherein the attach element indicates the size of the omitted attachment.

6. A method as in claim 1, wherein the synchronization client also indicates the size of at least some omitted parts.

7. A computer program product comprising a computer readable storage structure embodying computer program code thereon for execution by a computer processor, wherein said computer program code comprises instructions for performing a method including:
a step of determining an email to send to a client device and of determining what if any parts of the email to omit; and
a step of sending the email in whole or in part to the client device and of describing what if any parts of the email are omitted, wherein description is provided using an extensible markup language.

8. A method, comprising:
a step in which an email client apparatus having email client functionality and having email folders receives from a synchronization server apparatus an email in whole or in part as well as a description of what if any parts are omitted, wherein the description is provided using an extensible markup language; and
a step in which the email client displays information indicating whether only part of the email is received.

9. A computer program product comprising a computer readable storage structure embodying computer program code thereon for execution by a computer processor, wherein said computer program code comprises instructions for performing a method including:
a step of receiving from a server apparatus an email in whole or in part as well as a description of what if any parts are omitted, wherein description is provided using an extensible markup language; and
a step of displaying information indicating whether only part of the email is received.

10. A synchronization server apparatus, comprising:
means for determining an email to send to a synchronization client and for determining what if any parts of the email to omit; and
means for sending the email to the synchronization client in whole or in part and for describing what if any parts of the email are omitted, wherein the email is described using an extensible markup language.

11. A synchronization client apparatus having email folders, comprising:
means for receiving from a synchronization server apparatus an email in whole or in part as well as a description of what if any parts are omitted, wherein description is provided using an extensible markup language; and
means for displaying information indicating whether only part of the email is received.

12. A system, comprising a synchronization server apparatus including:
means for determining an email to send to a synchronization client and for determining what if any parts of the email to omit; and
means for sending the email to the synchronization client in whole or in part and for describing what if any parts of the email are omitted, wherein the email is described using an extensible markup language;
and also comprising at least one synchronization client apparatus having email folders and including:
means for receiving from the synchronization server apparatus an email in whole or in part as well as a description of what if any parts are omitted; and
means for displaying information indicating when only part of the email is received.
